(19) United States
(12) Patent Application Publication
(10) Pub. No.: US 2006/0204944 A1
(43) Pub. Date: Sep. 14, 2006

(54) System and method for providing educational and/or advertising materials

(76) Inventor: David Preskill, Highland Park, IL (US)

Correspondence Address: WELSH & KATZ, LTD, 120 S RIVERSIDE PLAZA, 22ND FLOOR, CHICAGO, IL, 60606, US

(21) Appl. No.: 10/551,170

(22) PCT Filed: Mar. 22, 2004
(86) PCT No.: PCT/US04/08723

§ 371 Date: Sep. 28, 2005

Related U.S. Application Data
(60) Provisional application No. 60/459,344, filed on Apr. 1, 2003.
(60) Provisional application No. 60/513,079, filed on Oct. 21, 2003.

(51) Int. Cl. G09B 7/00

(52) U.S. Cl. 434/322; 434/323

(57) ABSTRACT

A system and method for receiving content in a network including a cellular device. The content may include educational materials and/or advertising. The cellular device may be used to answer one or more questions that are related to the educational materials whereby successfully answering the one or more questions serves to earn continuing education credits. Advertising materials may be redeemed with a retailer to earn rewards, such as discounts, samples, cellular minutes, etc.

### RELATED APPLICATION DATA

This application claims the benefit of U.S. Provisional Patent Application Ser. No. 60/459,344 filed on Apr. 1, 2003 and U.S. Provisional Patent Application Ser. No. 60/513,079 filed on Oct. 21, 2003 which applications are herein incorporated by reference in their entirety.

### BACKGROUND

The following relates generally to communications networks and, more particularly, relates to a system and method for providing educational materials and/or advertising to a user via a communications network.

To maintain a professional license, many professionals are required to earn continuing education credits. While not exhaustive, examples of professions that typically require continuing education are medicine, law, accounting, real-estate sales, building construction and contracting, as well as education. To meet continuing education requirements, professionals often attend one or more conferences for which continuing education credits are earned. While attending conferences does allow the professional to meet any imposed continuing education requirements, attending a conference can be costly to the professional from both a standard of time, given travel and actual attendance time, and money, as not all dollar costs associated with attending a conference may be expensed or deducted from taxes.

In return for attending a professional conference, professionals may be provided with rewards in one or more forms. These rewards, which are most often provided by the sponsor of the professional conference, can include meals, product samples, etc. However, such rewards are generally not meaningful enough to induce a professional to attend a particular conference offered by a sponsor. Rather, when deciding which conference to attend, most professionals are more concerned with the overall costs associated with attendance.

To address some of the cost concerns of professionals, continuing educational materials are currently accessible via the Internet. By way of example, Innerlandscape, at www.innerlandscape.com, provides access to educational materials via the Internet. To access the on-line educational materials, the professional first registers with the service provider, e.g., by placing an order online or by phone and submitting a check or money order, and, in return, the professional is provided with an email including a link to relevant information, courses, and exams. The professional may then read the course materials, take a post test online, and then request to print a continuing education certificate. The system of the service provider will also keep a personal record of the completion of the online educational course. In this manner, Internet access to continuing educational materials eliminates costs associated with travel, hotels, parking, childcare, etc. However, accessing education materials via the Internet still suffers the disadvantage of requiring the professional to create time to sit in front of a computer. Furthermore, since many professionals are intimidated by the thought of using a computer and/or the Internet, using the Internet to earn continuing education credits has not found wide spread acceptance by professionals.

Accordingly, a need exists for an improved manner by which professionals may gain access to continuing educational materials, i.e., one that provides the professional with access to educational materials at a relatively lower cost, one that is flexible enough to fit with any time constraints imposed upon the professional, and one that is accessible via a device with which professionals are both familiar and comfortable. A need also exists for a system that provides professionals with relatively more meaningful rewards whereby sponsors of the continuing educational materials may entice an increased level of professional participation and, thereby, increase the level of exposure of the sponsor within a profession.

### SUMMARY

In order to address these and other needs, both individually and collectively, described hereinafter is a system and method for providing education materials and/or advertising materials to a user via a communications network. Generally, the system allows a professional to access educational materials and/or advertising where a wireless communication device, such as a cellular telephone, PDA, or the like, may be utilized to communicate an understanding of the educational materials, to receive the advertising materials, and/or redeem rewards associated with the advertising. To this end, the system may provide questions relevant to the educational materials and accept responses to those questions which are returned to the system via the wireless device. Similarly, a desire to redeem rewards associated with the advertising may be facilitated via the wireless device. A history of access to the database is preferably maintained which history may be used to reward the professional with various rewards, such as cellular minutes, electronic coupons, airline miles, dining dollars, points redeemable for products, etc.

A better understanding of the objects, advantages, features, properties and relationships of the system and method will be obtained from the following detailed description and accompanying drawing which sets forth illustrative embodiments which are indicative of the various ways in which the principles of the system and method may be employed.

### BRIEF DESCRIPTION OF THE DRAWINGS

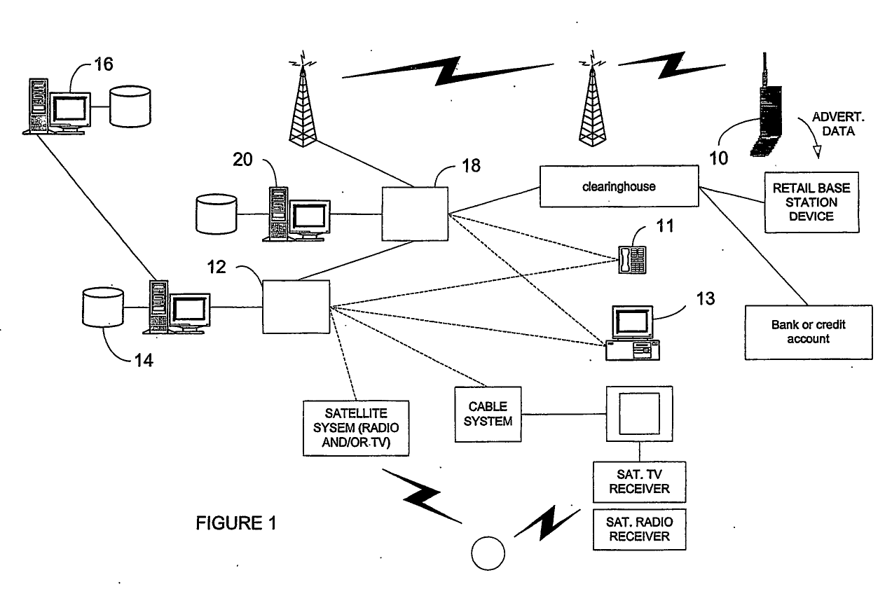

For a better understanding of the system and method, reference may be had to FIG. 1 which illustrates an exemplary network for providing and accessing educational information and/or advertising.

### DETAILED DESCRIPTION

Referring now to FIG. 1, a system and method for providing access to materials, e.g., educational materials and/or advertising, via a communication device. In the description that follows, the communication device is described in the context of a cellular telephone 10. In this regard, the cellular telephone 10 may be a voice only cellular phone or the cellular telephone 10 may provide additional capabilities, for example, text messaging and/or Internet capabilities. It is to be understood, however, that the communication device need not be limited to a cellular telephone 10 but may include any type of device having communication capabilities such as a PDA, Pager, Blackberry brand device, or the like. In accordance with a first described aspect, a professional may use the cellular telephone 10 to access materials at any time from any location to, for example, allow the professional to meet any continuing education requirements at the convenience of the professional, e.g., while commuting to and from the office, working in the yard, etc.

In the context of educational materials, access to the educational materials may require that the professional first register with a content provider system 12. Registration may include the professional providing to the content provider 12 information such as their name, billing address, home phone number, work phone number, system access password, etc. It will be appreciated that registration may be performed by means of mail, phone—using the cellular phone 10 or a land-line phone 11, Internet—using a personal computer 13, or the like. When registering via phone, registration may be performed by a live operator or may be automated using, for example, interactive voice response (IVR) technology and possibly speech recognition technology.

In some instances, the registration process may include the professional providing their cellular telephone number whereby access to educational material may be performed as a function of that telephone number, for example, in the case where the system of the content provider 12 is adapted to include automatic number identification (ANI) capabilities. It will also be appreciated that ANI may be used to allow the professional to access other information from the content provider 12 via telephones 10 and/or 11 which information may includes, by way of example, certification records, billing records, registration records, etc. Access to such information may also be made available via the Internet and personal computer 13. Preferably, the content provider system 12 requests the password of the professional before allowing access to any information.

Included as part of the content provider system 12 is a database 14 of educational material content. Preferably, the educational material content is divided into multiple small blocks to time, for example, a sixty minute education material session may be divided into six smaller sessions to allow for flexibility for user access. The educational material content is preferably audio although, in the case where the cellular telephone 10 has advanced capabilities, the educational material content may also include text, images and/or video. Thus, it is preferred that the professional provide the content provider 12 with an indication as to the capabilities of their cellular telephone 10, either during registration or during an interactive session, whereby the content provider system 12 may use such information to determine the one or more forms of the content that is to be delivered to the cellular telephone 10. In this regard, text, images, and/or video provided by the content provider 12 may include, for example, a sponsor name and/or logo that is displayed on the cellular telephone 10 of the professional during an interactive session with the content provider 12, test questions, etc. It will also be appreciated that the educational material content may be maintained solely by the content provider 12 or it may be downloaded, updated, etc. by a third party content provider 16.

Once the professional has registered with the content provider 12, the professional may access educational materials using their cellular telephone 10. In this regard, access to the content provider system 12 may be made toll-free to the professional. It will also be appreciated that the delivery of the educational materials may be initiated by the content provider. In either case, once linked to the content provider system 12, the specific educational materials that are delivered to the cellular telephone 10 may have been selected by the professional prior to the interactive session, for example, during registration, may be selected by the professional during the interactive session, for example, by interacting with the IVR system of the content provider 12, a graphical user interface menu, or the like, or the educational materials may not be selectable, i.e., the educational materials are predetermined by the content provider. Furthermore, during the delivery of the educational materials to the cellular telephone 10, the professional may be provided with the ability to stop the delivery to be resumed at a time later convenient to the professional, i.e., to pause the delivery of the content. To this end, the system of the content provider 12 may allow the professional to manually bookmark the education materials, for example, by interacting with the keys of the cellular phone 10, by voice command, a graphical user interface, etc., or may provide for automatic bookmarking, for example, should the professional disconnect from the content provider 12, either intentionally or unintentionally.

In some instances it may be desirable to cause the content provider system to issue to the professional a reminder as to an upcoming educational session. Such reminders may be sent at the discretion of the content provider system and/or the professional may interact with the system to setup a preferred reminder contact schedule as well as devices to which such reminders may be delivered. In this regard, reminders may also be sent to designates of the professional, such as a spouse or administrative assistant.

To ensure that the professional is listening and/or viewing the educational content, the provider system may also provide for the asking or one or more questions during and/or after an interactive session. Questions may be based in audio and/or text and responses to the questions may be entered using keys of the cellular phone, by interacting with a graphical user interface, or verbally, in the case where the system 12 have speech recognition capabilities. Preferably the questions are such that only a professional in the given field would be able to understand and answer the questions, for example, by using language unique to the profession. In this manner, it is further ensured that the professional will not have someone act as a sit-in on the educational materials. It is also contemplated that, in the case where verbal responses are solicited, a recording of one or more answers may be maintained to also act as a verification that the professional accessed and understood the educational materials.

In the event that an incorrect answer is provided to a question, the system may provide for the replaying of a segment (or segments) of the educational materials that includes information relevant to the question. To this end, the system may bookmark the educational materials, or the like, to provide a correspondence between segments of the educational materials and particular questions. It is to be understood that the review or replay of the relevant segment(s) of the educational material may be required or at the discretion of the professional. The professional may then be provided with a further opportunity to try and re-answer the question once a relevant segment of the educational material has been reviewed. In some instances, it may be desirable for the system to maintain a record of the number of times the question was posed to the professional before the professional answered the question correctly. This information may be used by the certification board in evaluating the skill level of the professional. Similarly, the information may be used to discern any relevant educational areas that the professional may need to take further educational classes in, i.e., the information is used to target further educational material that might be useful to the professional.

Upon completion of an interactive session, the content provider system 12 preferably maintains a record of the educational credits earned by the professional for participating in that interactive session. Reports as to a total number of education credits earned by the professional over a given time period, for example, quarterly or annually, may be automatically provided to the professional, may be requested by the professional, and/or delivered to a certification board or the like specified by the professional, for example, during the registration process. It is also preferred that the content provider system 12 have provision for archiving the records of the professional for a given number of years past.

As a means for rewarding the professional, the content provider 12 and/or sponsor (in the case where a sponsor is not a content provider) may allow the professional to earn rewards, such as cellular telephone minutes, airline miles, redeemable points, etc., by completing an interactive session. It is also contemplated that the content provider 12 and/or sponsor may provide the professional with cellular telephone minutes before or after an interactive session some or all of which may be used to access educational materials in the future. Yet further, the content provider 12 and/or sponsor may provide information by which a professional can request samples, e.g., pharmaceuticals, of a product content provider 12 and/or sponsor. In this latter regard, it is particularly contemplated that the materials may include advertising in the form of detailing which is generally advertising used to teach a health care professional about a medical product. A desire to receive samples may be indicated by the professional activating one or more keys of the cellular phone in response to a prompt—e.g. to use the numeric keypad to indicate the desire and possibly a requested amount, by calling a number provided in advertising, or the like. The registration information of the professional may be utilized in this regard to coordinate delivery of any samples.

Still further, it is contemplated that the content provider 12 and/or sponsor may provide the professional with the cellular telephone 10. In the latter case, the cellular telephone 10 may be imprinted with or otherwise caused to display a logo or like indicia of the content provider 12, sponsor, and/or sponsor products. It is especially contemplated that such advertising logos or indicia would be targeted based upon the demographics of the ultimate end user of the cellular telephone 10, for example, in the event the professional is a doctor, the logo or like indicia may be a logo/trademark for a particular drug provided by a sponsor. It is also contemplated that, in the case where the cellular telephone 10 has a display, displayed logos or indicia may be changeable, for example, being changed depending upon which one of the educational courses the professional elects to receive considering the sponsor of such educational course. Any rewards provided that are associated with the use of a cell phone may then be generally charged by the cellular provider 18 against the account of the content provider 12 and/or sponsor. Thus, it is additionally contemplated that the content provider 12 and/or sponsor would negotiate for the purchase of blocks of minutes and/or cellular phones with a cellular provider 18 at a bulk rate.

Yet further, it is contemplated that a provided cell phone may be setup—prior to the time it is given to the professional—with the number(s) that would be utilized to access the educational materials and/or advertising. For example, these numbers may be setup as speed dial numbers. Similarly, the cell phone may be provided with a speaker phone docking pod that includes a speed dial button that has been setup to allow access to educational material and/or advertising.

To track and manage the cellular minutes and any other rewards plans associated with the use of the cellular telephone 10, the content provider 12 is preferably in communication with the cellular service provider 18. Generally, the content provider 12 will inform the cellular service provider 18 with any changes to the cellular minutes and/or plans associated with the cellular telephone 10 which will then be reflected in the billing system 20 of the cellular service provider 18. The professional may also access the billing system 20 of the cellular service provider 18, for example, via telephones 10 and/or 11, via personal computer 13, etc., to determine a rewards account balance, e.g., the number of cellular minutes, etc., the professional has earned, has used, etc. by participating in the services offered by the content provider 12.

It will be appreciated that in some instances the cellular service provider 18 may also be the content provider 12 and/or sponsor.

In some instances, it may be desirous to allow the educational materials to be accessed via a conventional telephony system and allow the professional to answer questions via their conventional phone 11.

It may also be desirous to broadcast the educational materials to the professional, for example, by means of a conventional cable network, the Internet, satellite radio network, or the like as illustrated in FIG. 1. While not required, the broadcast of educational materials in this environment would generally occur at the discretion of the content provider. Furthermore, the communication device, for example, cell phone 10, PDA, pager, etc., may still be used to answer questions related to the educational materials broadcast to the professional. In this regard, the questions may be posed as part of the broadcast and/or may be directed to the communication device 10. Again, provision may be made to replay all or part of the educational materials in cases where a question have not been answered correctly. The replay of materials may occur by general rebroadcast or by delivery directly to the profession, e.g., via their communication device 10. In such a broadcast environment, the professional may be again supplied with any subscriptions and/or equipment required to access the broadcast materials, e.g., a satellite radio receiver and subscription.

As above-noted, provision may be made to supply advertising to the communication device, e.g., cell phone 10. This advertising may further include, for example, discounts, offers for samples, a give-away, etc. Thus, associated with the advertising would be some data that is reflective of the discount, etc. which data would be maintained within the communication device. This data may include data that is readable when the communication device is docked in a cradle, for example, being associated with a retail cash register, point of purchase device, computer, etc. Furthermore, the data may also include data that is readable by a base station in the form of a bar code scanner, e.g., it may be presented as a label within displayable advertising, readable by a base station in the form on an RF reader, e.g., where the communication device would include an RF transmitter, and the like. Preferably, the base station will be associated with a device capable of communicating with a data store whereby the data received from the communication device may be examined to determine if the advertisement redemption is and remains valid.

By way of further example, the communication device might be provided with a readable label, e.g., such as bar code label, that will be linked, e.g., within a centralized server, to an offer, e.g., such as a discount reflected in an advertisement. In such a case, the label may be read by a device associated with a merchant and the offer, that has been linked to the communication device (and accordingly owner) by its label, accessed within the centralized server and retrieved whereby further action may be taken in keeping with the offer.

In the case where redemption of advertising results in a discount, e.g., reduction in sales prices, cash back, or the like, the retailer can provide the discount at the time of sale (and seek reimbursement from the sponsor of the advertisement) or an account, such as the cell phone account, a credit card account, or the like, that has been associated with the communication device can be provided a credit, etc. Thus, it will be appreciated that the retailer base station system would normally be in contact with a clearinghouse site whereby the credit amount can be provided to the appropriate account, which account would be associated with the some identifier associated with the user, e.g., such as a cell phone number and/or credit card tied to the cell phone number. While not required, the crediting of an account may be delayed a predetermined time, e.g., a month, to allow for a return of a purchased product, etc.

It will also be appreciated that in connection with the downloading of advertising information and personal identifier data to the retail system during the advertising redemption process, the base station may also be utilized to erase the current advertising and/or upload additional advertising into the communication device. Any newly uploaded advertising may be adapted to be continuously displayed or periodically displayed, e.g., at certain times, in response to certain events—such as broadcast of educational content, etc., without limitation. Usage of such a system may also be tracked, for example by a server associated with a validating data store, whereby targeted advertising may be further directed to the user of the communication device. Again, the targeted advertisement may be transmitted to the cellular device via the cellular network and/or may be uploaded to the cellular device during a docking procedure.

As noted, it will also be appreciated that an advertising related reward may include the awarding of redeemable points. For example, the advertising may specify a product that may be purchased which, if purchased, will result in points being awarded to an account associated with the communication device. Point thresholds may then be established which, when met, may allow the points to be redeemed for further rewards. Examples includes airline miles, dining dollars, hotel points, points redeemable for merchandise, etc. Points may also be awarded for a user simply making their device available to receive advertising, for example for each advertisement sent or sent and confirmed to have been reviewed may cause reward points for that user to be accumulated in a central repository. Confirmation may be accomplished by a user interacting with the system via their device or through another connection means, such as by placing a phone call, accessing an Internet Web site, etc. Confirmation may also require the user to answer a question pertinent to the advertisement.

While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

What is claimed is:

1. A method for accessing educational materials, comprising:
using a cellular device to access the educational materials; and
using the cellular device to answer one or more questions that are related to the educational materials whereby successful answering of the one or more questions serves to earn continuing education credits.

2. The method as recited in claim 1, further comprising using a key of the cellular device to answer the one or more questions.

3. The method as recited in claim 1, further comprising speaking into the cellular device to answer the one or more questions.

4. The method as recited in claim 1, further comprising requesting that access to the educational materials be stopped and that the educational materials be bookmarked.

5. A system for providing access to educational materials, comprising:
a server having access to a database in which the educational materials are stored, the server and the educational materials stored in the database being accessible via a cellular connection.

6. The system as recited in claim 5, wherein the server further stores in the database data representative of user access to the educational materials.

7. The system as recited in claim 6, wherein the server is further accessible via the Internet for use in retrieving the data representative of user access to the educational materials.

8. The system as recited in claim 5, wherein the database further maintains questions related to the educational materials which, if successfully answered, serve to verify user access to the educational materials.

9. The system as recited in claim 8, wherein the server further stores in the database data representative of continuing education credits earned by a user for accessing the educational materials.

10. The system as recited in claim 5, wherein the server is in communication with a cellular phone system to effect a change in cellular minutes which are provided to a user in response to a user accessing the educational materials.

11. The system as recited in claim 5, wherein the educational materials are stored on the database as audio files.

12. The system as recited in claim 11, wherein the educational materials further comprise image files.

13. The system as recited in claim 5, wherein the server comprises a voice response system to provide a means for user access to the educational materials.

14. The system as recited in claim 5, wherein the server comprises an automated number identification system to provide a means for user access to the educational materials.

15. A method for providing educational materials to a user, comprising:
allowing a user to access via a cellular connection a database in which the educational materials are stored;
providing questions relevant to the educational materials to the user via the cellular connection;
accepting responses to the questions via the cellular connection; and
maintaining a history of the user access to the database.

16. The method as recited in claim 15, further comprising providing cellular minutes to the user as a reward for the user accessing the database.

17. The method as recited in claim 15, further comprising generating a report of the history of the user access to the database.

18. The method as recited in claim 17, further comprising allowing the report to be accessible via the Internet.

19. The method as recited in claim 15, further comprising accepting voice responses to the questions.

20. The method as recited in claim 19, further comprising storing at least a portion of the voice responses.

21. The method as recited in claim 15, further comprising accepting user input that selects the educational materials.

22. The method as recited in claim 21, wherein an IVR system is used to accept the user input that selects the educational materials.

23. The method as recited in claim 15, wherein the educational materials comprise audio files.

24. The method as recited in claim 24, wherein the educational materials comprise image files.

25. A method for accessing educational materials, comprising:
accessing educational materials; and
using a cellular device to answer one or more questions that are related to the educational materials whereby successful answering of the one or more questions serves to earn continuing education credits.

26. The method as recited in claim 25, wherein the educational materials are broadcast via a satellite network.

27. The method as recited in claim 25, wherein the educational materials are broadcast via the Internet.

28. The method as recited in claim 25, wherein the educational materials are accessed via a POTS phone system.

29. The method as recited in claim 25, wherein the educational materials are accessible in timed segments.

30. The method as recited in claim 29, wherein the timed segments are less than an hour.

31. A method for redeeming rewards associated with advertising, comprising:
receiving with a cellular device an advertisement including data representative of the reward; and
causing the cellular device to download the data into a docking station of a retailer for validation that the reward is redeemable.

32. The method as recited in claim 31, comprising erasing the advertising from the cellular device after validation.

33. The method as recited in claim 31, comprising using the docking device to upload new advertising to the cellular device.

34. A method for redeeming rewards associated with advertising, comprising:
receiving an advertisement including data representative of the reward with a cellular device; and
causing the cellular device to download the data into a docking station; and
communicating the data to a clearinghouse whereby an account associated with the cellular device is provided with a credit amount.

35. The method as recited in claim 34, wherein the account is a cellular phone account and the credit comprises usage minutes.

36. The method as recited in claim 34, wherein the account is a credit card account and the credit comprises a dollar value.

37. A method for providing redeemable rewards credit amounts, comprising:
transmitting an advertisement to a cellular device of the user;
crediting a rewards account associated with the user with a rewards credit amount upon receiving confirmation that the user has viewed the advertisement; and
making accumulated rewards credit amounts available to the user for purposes of redemption.

38. The method as recited in claim 37, wherein confirmation is received via the cellular device.

39. The method as recited in claim 38, wherein confirmation comprises the user interacting with keys of the cellular device.

40. The method as recited in claim 38, wherein confirmation comprises the user providing a voice response via the cellular device.

41. The method as recited in claim 40, comprising providing a prompt for eliciting the voice response.

42. The method as recited in claim 41, wherein the prompt comprises a question related to the advertisement.

43. The method as recited in claim 37, wherein the rewards credit amount comprises airline miles.

44. The method as recited in claim 37, wherein the rewards credit amount comprises cellular minutes.

45. The method as recited in claim 37, wherein the rewards credit amount comprises a cash value for discounting merchandise.

46. The system as recited in claim 5, wherein the educational materials comprise multiple segments which are individually accessible.

47. The system as recited in claim 46, wherein the segments are approximately 10 to 15 minutes in length.

48. The system as recited in claim 5, wherein the education material comprises medical detailing advertisements.
